(19) United States
(12) Patent Application Publication
(10) Pub. No.: US 2005/0165210 A1
(43) Pub. Date: Jul. 28, 2005

(54) Transparent copolymers having polyamide blocks and polyether blocks

(76) Inventors: Frederic Malet, Rouen (FR); Annett Linemann, Bernay (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/690,824

(22) Filed: Oct. 23, 2003

(30) Foreign Application Priority Data
Oct. 23, 2002 (FR) 02.13218

(51) Int. Cl. C08G 69/08

(52) U.S. Cl. 528/310

(57) ABSTRACT

The present invention relates to copolymers having polyamide blocks and polyether blocks, in which:
the polyether blocks essentially consist of PTMG having a number-average molar mass \overline{M}ₙ of between 200 and 4000 g/mol; the polyamide blocks are formed from a linear (noncyclic, nonbranched) aliphatic predominantly semicrystalline monomer and from a sufficient amount of at least one comonomer to reduce their crystallinity, while remaining immiscible with the polyether amorphous blocks; and the shore D hardness is between 20 and 70. These copolymers are useful for manufacturing many articles and in particular sports shoes.

### FIELD OF THE INVENTION

The present invention relates to transparent copolymers having polyamide blocks and polyether blocks. They are also called polyether-block-amides (PEBA), these being thermoplastic elastomers. They are also called elastomeric polyamides. These copolymers are useful for manufacturing many articles and in particular sports shoes. The transparency of the copolymers of the present invention is measured on sheets 2 to 4 mm in thickness.

### PRIOR ART AND THE TECHNICAL PROBLEM

Many patent applications disclose copolymers having polyamide blocks and polyether blocks.

U.S. Pat. No. 4,820,796 discloses copolymers having polyamide blocks and polyether blocks, the polyamide blocks of which are made of PA-6 (nylon-6 or polycaprolactam) and the polyether blocks are made of PTMG (polytetramethylene glycol or polyoxytetramethylene glycol or polytetrahydrofuran) having a number-average molar mass \overline{M}ₙ of between 680 and 4040. They have insufficient transparency.

U.S. Pat. No. 5,280,087 discloses copolymers having polyamide blocks and polyether blocks, the polyamide blocks of which are made of PA-6 (nylon-6 or polycaprolactam) and the polyether blocks are made of PTMG (polytetramethylene glycol or polyoxytetramethylene glycol or polytetrahydrofuran) having a number-average molar mass \overline{M}ₙ of between 1000 and 2000. They have insufficient transparency.

Novel copolymers having polyamide blocks and polyether blocks have now been found, such that their polyamide blocks are microcrystalline copolyamides that are immiscible with the polyether blocks and their polyether blocks are made of PTMG having a number-average molar mass \overline{M}ₙ of between 200 and 4000. These copolymers are particularly transparent within the meaning of the invention. Advantageously, their Shore D hardness is between 20 and 70. On contact with moisture or with water, they have a low water uptake, allowing good mechanical properties.

The prior art has already disclosed copolymers having polyamide blocks and polyether blocks whose polyamide blocks are made of a copolyamide, but they are always associated with hydrophilic polyether blocks.

Patent application JP 05078477 A, published on Mar. 30, 1993, discloses copolymers having polyamide blocks and polyether blocks with copolyamide blocks, but the polyether blocks are a blend of PTMG and PEG (polyethylene glycol or polyoxyethylene glycol) containing between 30 and 99% by weight of PEG. The number-average molar mass \overline{M}ₙ of the PTMG is between 1000 and 2000. The number-average molar mass \overline{M}ₙ of the PEG is between 1000 et 2020. They are used for making resins antistatic. It is also stated that they have excellent water vapor permeability properties.

Patent application WO 99/33659 discloses a multilayer structure comprising a material covered by a copolymer having polyamide blocks and hydrophilic blocks, said copolymer having a melting point below 135° C. and preferably between 90 and 135° C. The polyamide blocks are of low mass or are copolyamides. The hydrophilic blocks of the copolymer are polyether blocks having at least 50% by weight of the following units:
C₂H₄O

The amount of polyether blocks of the copolymer represents 10 to 40% by weight of the copolymer. The material of this multilayer structure is paper, board, a cellulose fiber nonwoven, a nonwoven based on polyolefin fibers, or a woven fabric chosen from cotton, polyamide or polyester.

Patent application EP 1 046 675 discloses copolymers having polyamide blocks and polyether blocks which are similar to those of the structure described above in the structure according to WO 99/33659. They are useful as additives in thermoplastic polymers in order to make them antistatic.

### BRIEF DESCRIPTION OF THE INVENTION

The present invention relates to copolymers having polyamide blocks and polyether blocks, in which:
the polyether blocks essentially consist of PTMG having a number-average molar mass \overline{M}ₙ of between 200 and 4000 g/mol;
the polyamide blocks are formed from a linear (noncyclic, nonbranched) aliphatic predominantly semicrystalline monomer and from a sufficient amount of at least one comonomer to reduce their crystallinity, while remaining immiscible with the polyether amorphous blocks; and
the shore D hardness is between 20 and 70.

The transparency is defined as being an opacity of less than 12% for a specimen at least 2 mm in thickness.

The invention also relates to the articles manufactured with these copolymers. They may be manufactured by injection molding, compression molding and extrusion, and in general using the techniques for converting thermoplastic polymers. For example, sheets from 0.5 to 4 mm in thickness are useful for making soles for sports shoes.

### DETAILED DESCRIPTION OF THE INVENTION

The copolymers having polyamide blocks and polyether blocks result in general from the copolycondensation of polyamide blocks having reactive end groups with polyether blocks having reactive end groups, such as, inter alia:
1) polyamide blocks having diamine chain ends with polyoxyalkylene blocks having dicarboxylic chain ends;
2) polyamide blocks having dicarboxylic chain ends with polyoxyalkylene blocks having diamine chain ends, obtained by cyanoethylation and hydrogenation of aliphatic dihydroxylated alpha, omega-polyoxyalkylene blocks called polyetherdiols; and
3) polyamide blocks having dicarboxylic chain ends with polyetherdiols, the products obtained being, in this particular case, polyetheresteramides.

The polyamide blocks having dicarboxylic chain ends derive, for example, from the condensation of polyamide precursors in the presence of a dicarboxylic acid chain stopper.

The polyamide blocks having diamine chain ends derive, for example, from the condensation of polyamide precursors in the presence of a diamine chain stopper.

The polymers having polyamide blocks and polyether blocks may also include randomly distributed units. These polymers may be prepared by the simultaneous reaction of the polyether with the polyamide block precursors.

For example, it is possible to react a polyetherdiol, polyamide precursors and a diacid chain stopper. What is obtained is a polymer having essentially polyether blocks and polyamide blocks of very variable length, but also the various reactants, having reacted in a random fashion, are distributed randomly along the polymer chain.

It is also possible to react a polyetherdiamine, polyamide precursors and a diacid chain stopper. What is obtained is a polymer having essentially polyether blocks and polyamide blocks of very variable length, but also the various reactants, having reacted in a random fashion, are distributed randomly along the polymer chain.

With regard to the polyamide blocks the semicrystalline monomer may be a linear aliphatic alpha, omega-aminocarboxylic acid (called amino acid in the rest of the text), a lactam (corresponding to a linear aliphatic alpha, omega-aminocarboxylic acid) or a diamine associated with a diacid; both these being aliphatic and linear.

As an example of aliphatic alpha, omega-aminocarboxylic acids, mention may be made of aminocaproic, 7-aminoheptanoic, 11-aminoundecanoic and 12-aminododecanoic acids. As examples of lactams, mention may be made of caprolactam, oenantholactam and lauryllactam. As examples of aliphatic diamines, mention may be made of hexamethylenediamine and dodecamethylenedamine. As examples of aliphatic diacids, mention may be made of butanedioic, adipic, azelaic, suberic, sabacic and dodecanedicarboxylic acids.

With regard to the semicrystalline monomer formed by a diamine associated with a diacid, both being aliphatic and linear, aliphatic polyamides resulting from the condensation of an aliphatic diamine having from 6 to 12 carbon atoms and an aliphatic diacid having from 9 to 12 carbon atoms are preferred.

As examples of aliphatic polyamides resulting from the condensation of an aliphatic diamine having from 6 to 12 carbon atoms and an aliphatic diacid having from 9 to 12 carbon atoms, mention may be made of:
PA-6,12 resulting from the condensation of hexamethylenediamine and 1,12-dodecanedioic acid;
PA-9,12 resulting from the condensation of the C₉ diamine and 1,12-dodecanedioic acid;
PA-10,10 resulting from the condensation of the C₁₀ diamine and 1,10-decanedioic acid; and
PA-10,12 resulting from the condensation of the C₉ diamine and 1,12-dodecanedioic acid.

A comonomer is introduced in order to disorganize the crystal lattice and thus increase the transparency, while maintaining sufficient crystallinity for there to be phase separation between the polyamide blocks and the PTMG blocks, thereby making it possible to maintain good mechanical properties. This comonomer may be any comonomer: it may be a lactam; it may be an alpha, omega aminocarboxylic acid; it may be a diamine associated with a diacid. Mention may also be made, for example, of unbranched linear, branched and cyclic monomers.

Advantageously, a lactam, an alpha,omega-aminocarboxylic acid, a cyclic diamine associated with a diacid, preferably associated with a linear aliphatic diacid, for example sebacic acid, are used. The cyclic diamine may be IPD (isophorone diamine) or PACM 20 (bis(p-aminocyclohexyl)methane having the following formulae:

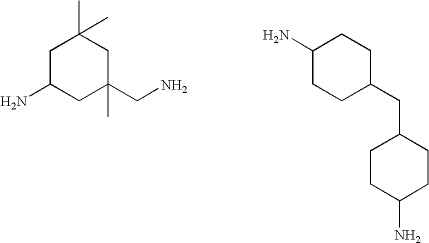

Advantageously, the predominantly crystalline monomer is lactam 12. The T_{g} of PA-12 is 50° C.; a comonomer is added in order to increase the T_{g}, preferably up to 70° C., and therefore to reduce the crystallinity. Advantageously, the polyamide blocks are formed from lactam 12 (predominantly crystalline) and IPD 10 (isophorone diamine and sebacic acid) or lactam 12 and PACM 12 (PACM 20 and C₁₂ diacid). According to another version, the polyamide blocks are formed from lactam 12 (predominantly crystalline) and lactam 6 or from 11-aminoundecanoic acid. According to another version, the polyamide blocks are formed from lactam 12 (predominantly crystalline) and from lactam 6 and 11-aminoundecanoic acid.

With regard to the proportions of the crystalline monomer and of the comonomer that disorganizes the crystal lattice, the crystalline monomer advantageously represents at least 55%, and preferably at least 70%, by weight of the constituents of the polyamide blocks.

The polyamide blocks are obtained in the presence of a diacid chain stopper or a diamine chain stopper, depending on whether polyamide blocks having acid or amine end groups are desired. If the precursors already include a diacid or a diamine, it is sufficient, for example, to use it in excess.

The number-average molar mass \overline{M}ₙ of the polyamide blocks may be between 500 and 10 000, preferably between 500 and 4500.

As examples of polyamide blocks, mention may also be made of:
6/11/12 blocks that result from the condensation of caprolactam, 11-aminoundecanoic acid and lauryllactam, it being possible for the proportions by weight to be 10 to 20/20 to 40/50 to 80, respectively. The number-average molar mass \overline{M}ₙ of these polyamide blocks may be between 500 and 4200.

Mention may also be made of 6/12 blocks which result from the condensation of caprolactam and lauryllactam. The proportions by weight may be from 18 to 45% of caprolactam per 55 to 82% of lauryllactam respectively. The number-average molar mass \overline{M}ₙ of these polyamide blocks may be between 1000 and 3000.

The polyether blocks may represent 5 to 85% by weight of the copolymer having polyamide and polyether blocks. The polyether blocks consist of tetrahydrofuran units, which results in polytetramethylene glycol (also called PTMG) chain sequences that may be represented by the formula:
HOCH₂CH₂CH₂CH₂—OₙH

It would not be outside the scope of the invention if the polyether blocks were to contain small proportions of other alkylene oxides provided that the properties of the copolymer of the invention are preserved. The expression “small proportions” is understood to mean a proportion by weight of around 5% at most. Likewise, the copolymer of the invention may contain polyethers other than PTMG, provided that the properties of the copolymer of the invention are preserved.

The amount of polyether blocks in these copolymers having polyamide blocks and polyether blocks is advantageously from 10 to 40%, preferably 10 to 25%, by weight of the copolymer.

The polyetherdiol blocks are either used as such and copolycondensed with polyamide blocks having carboxylic end groups, or they are aminated in order to be converted to polyetherdiamines and condensed with polyamide blocks having carboxylic end groups. To simplify matters, the name PTMG block will be retained for the polyether blocks deriving from polytetramethylene glycol(polyetherdiol) whose OH end groups have been replaced with NH₂ functional groups, and then condensed with the polyamide blocks. They may also be blended with polyamide precursors and a diacid chain stopper in order to make polymers having polyamide blocks and polyether blocks with randomly distributed units.

The mass \overline{M}ₙ of the polyether blocks is advantageously between 300 and 1100 and preferably between 300 and 700.

With regard to the Shore D hardness, this is advantageously between 40 and 70. The hardness increases with the proportion of polyamide relative to the PTMG. The higher the mass of polyamide blocks, with the PTMG blocks remaining the same, the higher the hardness.

The copolymers of the invention may also be characterized by their intrinsic viscosity. These polymers having polyamide blocks and polyether blocks that derive from the copolycondensation of polyamide blocks and polyether blocks prepared beforehand or from a one-step reaction have, for example, an intrinsic viscosity between 0.8 and 2.5 measured in metacresol at 25° C. for an initial concentration of 0.8 g/100 ml.

With regard to their preparation, the copolymers of the invention may be prepared by any means allowing the polyamide blocks to be linked with the polyether blocks. In practice, two processes are used, one a two-step process and the other a one-step process. In the two-step process, the polyamide blocks are firstly manufactured and then in a second step the polyamide blocks are linked to the polyether blocks. In the one-step process, the polyamide precursors, the chain stopper and the polyether are blended together; what is then obtained is a polymer having essentially polyether blocks and polyamide blocks of very variable length, but also the various reactants, having reacted randomly, which are randomly distributed along the polymer chain. Whether in one step or in two steps, it is advantageous to carry out the process in the presence of a catalyst. The catalysts disclosed in patents U.S. Pat. No. 4,331,786, U.S. Pat. No. 4,115,475, U.S. Pat. No. 4,195,015, U.S. Pat. No. 4,839,441, U.S. Pat. No. 4,864,014, U.S. Pat. No. 4,230,838 and U.S. Pat. No. 4,332,920 may be used. In the one-step process, polyamide blocks are also manufactured and this is why it was stated, at the beginning of this paragraph, that the copolymers of the invention could be prepared by any means of linking the polyamide blocks to the polyether blocks. Processes for preparing these copolymers are also disclosed in patent application WO 99/33659 and patent application EP 1 046 675.

The preparation processes in which the polyamide blocks are blocks having carboxylic end groups and the polyether is a polyetherdiol will now be described in detail.

The 2-step process firstly consists in preparing the polyamide blocks having carboxylic end groups by condensation of the polyamide precursors in the presence of a dicarboxylic acid chain stopper, and then, in a second step, in adding the polyether and a catalyst. If the polyamide precursors are only lactams or alpha, omega-aminocarboxylic acids, a dicarboxylic acid is added. If the precursors already include a dicarboxylic acid, this is used in excess with respect to the stoichiometry of the diamines. The reaction is usually carried out between 180 and 300° C., preferably 200 to 290° C., the pressure in the reactor is set between 5 and 30 bar and is maintained for 2 to 3 hours. The pressure is slowly reduced, bringing the reactor to atmospheric pressure, and then the excess water is distilled, for example for one or two hours.

Having prepared the polyamide having carboxylic acid end groups, the polyether and a catalyst are then added. The polyether may be added in one or more steps, as may the catalyst. According to an advantageous embodiment, the polyether is firstly added, the reaction of the OH end groups of the polyether with the COOH end groups of the polyamide starting with the formation of ester linkages and removal of water. As much water as possible is removed from the reaction mixture by distillation, and then the catalyst is introduced in order to complete the linking of the polyamide blocks to the polyether blocks. This second step is carried out with stirring, preferably in a vacuum of at least 6 mm Hg (800 Pa) at a temperature such that the reactants and the copolymers obtained are in the melt state. As an example, this temperature may be between 100 and 400° C. and usually between 200 and 300° C. The reaction is monitored by measuring the torque exerted by the polymer melt on the stirrer or by measuring the electrical power consumed by the stirrer. The end of the reaction is determined by the target value of the torque or power. The catalyst is defined as being any product making it easier to link the polyamide blocks to the polyether blocks by esterification. The catalyst is advantageously a derivative of a metal (M) chosen from the group formed by titanium, zirconium and hafnium.

As examples of derivatives, mention may be made of tetraalkoxides which satisfy the general formula M(OR)₄, in which M represents titanium, zirconium or hafnium and the Rs, which are identical or different, denote linear or branched alkyl radicals having from 1 to 24 carbon atoms.

The C₁ to C₂₄ alkyl radicals from which the radicals R of the tetraalkoxides used as catalysts in the process according to the invention are chosen are, for example, methyl, ethyl, propyl, isopropyl, butyl, ethylhexyl, decyl, dodecyl and hexadodecyl. The preferred catalysts are tetraalkoxides for which the radicals R, which are identical or different, are C₁ to C₈ alkyl radicals. Examples of such catalysts are, for example, Zᵣ(OC₂H₅)₄, Zᵣ(O-isoC₃H₇)₄, Zᵣ(OC₄H₉)₄, Zᵣ(OC₅H₁₁)₄, Zᵣ(OC₆H₁₃)₄, H_{f}(OC₂H₅)₄, H_{f}(OC₄H₉)₄ and H_{f}(O-isOC₃H₇)₄.

The catalyst used in this process according to the invention may consist only of one or more of the tetraalkoxides of formula M(OR)₄ defined above. It may also be formed by the combination of one or more of these tetraalkoxides with one or more alkaline or alkaline-earth metal alcoholates of formula (R₁O)ₚY, in which R₁ denotes a hydrocarbon residue, advantagaeously a C₁ to C₂₄, preferably C₁ to C₈, alkyl residue, Y represents an alkali or alkaline-earth metal and p is the valence of Y. The amounts of alkali or alkaline-earth metal alcoholate and of zirconium or hafnium tetraalkoxides that are combined in order to constitute the mixed catalyst may vary widely. However, it is preferred to use amounts of alcoholate and tetraalkoxides such that the molar proportion of alcoholate is substantially equal to the molar proportion of tetraalkoxide.

The weight proportion of the catalyst, that is to say of the tetraalkoxide(s) when the catalyst does not contain an alkali or alkaline-earth metal alcoholate, or else the combination of the tetraalkoxide(s) and the alkali or alkaline-earth alcoholate(s) when the catalyst is formed by the combination of these two types of compounds varies advantageously from 0.01 to 5% by weight of the blend of the dicarboxylic polyamide with the polyoxyalkylene glycol, and preferably is between 0.05 and 2% of this weight.

As examples of other derivatives, mention may also be made of the salts of the metal (M), in particular the salts of (M) and of an organic acid and the complex salts between the oxide of (M) and/or the hydroxide of (M) and an organic acid. Advantageously, the organic acid may be formic acid, acetic acid, propionic acid, butyric acid, valeric acid, caproic acid, caprylic acid, lauric acid, myristic acid, palmitic acid, stearic acid, oleic acid, linoleic acid, linolenic acid, cyclohexane carboxylic acid, phenylacetic acid, benzoic acid, salicylic acid, oxalic acid, malonic acid, succinic acid, glutaric acid, adipic acid, maleic acid, fumaric acid, phthalic acid, and crotonic acid. Acetic and propionic acids are particularly preferred. Advantageously, M is zirconium. These salts may be called zirconyl salts. The Applicant, without being tied to this explanation, believes that these salts of zirconium and an organic acid, or the complex salts mentioned above, liberate ZrO⁺⁺ during the process. The product sold under the name zirconyl acetate is used. The amount to be used is the same as in the case of the M(OR)₄ derivatives.

This process and these catalysts are described in the patents U.S. Pat. No. 4,332,920, U.S. Pat. No. 4,230,838, U.S. Pat. No. 4,331,786, U.S. Pat. No. 4,252,920, JP 07145368A, JP 06287547A, and EP 613 919.

With regard to the one-step process, all the reactants used in the two-step process, that is to say the polyamide precursors, the dicarboxylic acid chain stopper, the polyether and the catalyst, are mixed together. They are the same reactants and the same catalyst as in the two-step process described above. If the polyamide precursors are only lactams, it is advantageous to add a little water.

The copolymer has essentially the same polyether blocks and the same polyamide blocks, but also a small portion of the various reactants, having reacted randomly, which are randomly distributed along the polymer chain.

The reactor is closed and heated with stirring, as in the first step of the two-step process described above. The pressure is set between 5 and 30 bar. When there is no further change, the reactor is put under reduced pressure, while maintaining vigorous stirring of the molten reactants. The reaction is monitored as above in the case of the two-step process.

The catalyst used in the one-step process is preferably a salt of the metal (M) and of an organic acid or a complex salt between the oxide of (M) and/or hydroxide of (M) and an organic acid.

Dyes, pigments, fillers, UV stabilizers and antioxidants may be added to the copolymers of the invention.

### EXAMPLES

### Example 1

Synthesis of a 6/11/12-PTMG copolymer in which the PA block was 4000 g/mol and the 6/11/12 components were in the ratio of 10/30/60, and in which the polyether was PTMG of 650 \overline{M}ₙ.

The following monomers were introduced into an autoclave fitted with a stirrer: 2.49 kg of lactam 6, 7.5 kg of 11-aminoundecanoic acid, 15 kg of lactam 12 and 0.96 kg of adipic acid. The mixture thus formed was put in an inert atmosphere and heated until the temperature reached 280° C. and the pressure reached 25.5 bar. After holding for 3 h, a pressure reduction operation was then carried out over 2 h in order to return to atmospheric pressure. Polytetramethylene glycol of 650 g/mol mass (4 kg) and Zr(OBu)₄ (30 g) were then added to the reactor in order to terminate the polymerization at 240° C. and at an absolute pressure of 8 mbar (i.e. 800 Pa). The final product had an inherent viscosity of 1.5 dl/g and an MFI (235° C./2.16 kg) of 6.15 g/10 min. The injection molding of 100×100×2 mm plaques confirmed the transparency of the product with a transmission of 68% at 460 nm, 78% at 560 nm and 85% at 700 nm, and an opacity of about 13%.

### Example 2

Synthesis of a 6/12-PTMG copolymer in which the PA block was 1300 g/mol and the 6/12 components were in the ratio 20/80 and in which the polyether was PTMG of 650 \overline{M}ₙ.

The following monomers were introduced into an autoclave fitted with a stirrer: 3.60 kg of lactam 6, 14.40 kg of lactam 12 and 2.32 kg of adipic acid. The mixture thus formed was put into an inert atmosphere and heated until the temperature reached 280° C. and the pressure 22 bar. After holding for 3 h, a pressure reduction operation was then carried out over 2 h in order to return to atmospheric pressure. Polytetramethylene glycol of 650 g/mol mass (9.8 kg) and Zr(OBu)₄ (60 g) were then added to the reactor in order to terminate the polymerization at 240° C. and at an absolute pressure of 13 mbar (1300 Pa). The final product had an inherent viscosity of 1.5 dl/g and an MFI (235° C./1 kg) of 10.5 g/10 min. The injection molding of 100×100×2 mm plaques confirmed the transparency of the product with a transmission of 66% at 460 nm, 77% at 560 nm and 84% at 700 nm, and an opacity of about 12%.

### Examples 3-7

The results are given in table 1, in which:
IPD 10 denotes the condensation of isophorone diamine with sebacic acid;
PTMG₆₅₀ denotes PTMG with a number-average molar mass of 650, the proportion of PTMG being expressed in the form of the combination with the C₁₀ acid;
PTMG₁₀₀₀ denotes PTMG with a number-average molar mass of 1000, the proportion of PTMG being expressed in the form of the combination with the C₁₀ acid;

PACM 12 denotes the condensation of PACM 20 with the C₁₂ acid, the proportion of PTMG being expressed in the form of the combination with the C₁₂ acid.

TABLE 1

| | | | | | | | Size of | |
|---|---|---|---|---|---|---|---|---|
| | | | | | | | the PA | |
| | Composition by weight | | | Molar composition | | | block | Shore |
| Ex. | 12 | IPD 10 | PTMG₆₅₀10 | 12 | IPD 10 | PTMG₆₅₀ 10 | (g/mol) | hardness |
| 3 | 37 | 29 | 34 | 4.7 | 1.95 | 1 | 1780 | |
| 4 | 57.6 | 19.8 | 22.6 | 11 | 2 | 1 | 3043 | |
| 5 | 62.8 | 17.3 | 19.8 | 13.7 | 2 | 1 | 3579 | |
| | | | | | | | Size of | |
| | | | | | | | the PA | |
| | Composition by weight | | | Molar composition | | | block | Shore |
| Ex. | 12 | IPD 10 | PTMG₁₀₀₀10 | 12 | IPD 10 | PTMG₁₀₀₀ 10 | (g/mol) | hardness |
| 6 | 58.1 | 16 | 25.9 | 13.7 | 2 | 1 | 3579 | |
| | | | | | | | Size of | |
| | | | | | | | the PA | |
| | Composition by weight | | | Molar composition | | | block | Shore |
| Ex. | 12 | PACM 12 | PTMG₆₅₀ 12 | 12 | PACM 12 | PTMG₆₅₀12 | (g/mol) | hardness |
| 7 | 55.2 | 22.4 | 22.4 | 11 | 2 | 1 | 3189 | |

1. A copolymer having polyamide blocks and polyether blocks, in which:
the polyether blocks essentially consist of PTMG having a number-average molar mass \overline{M}ₙ, of between 200 and 4000 glmol;
the polyamide blocks are formed from a linear (noncyclic, nonbranched) aliphatic predominantly semicrystalline monomer and from a sufficient amount of at least one comonomer to reduce their crystallinity, while remaining immiscible with the polyether amorphous blocks; and
the shore D hardness is between 20 and 70.

2. The copolymer as claimed in claim 1, in which the predominantly semicrystalline monomer is chosen from 11-aminoundecanoic acid and lauryllactam.

3. The copolymer as claimed in claim 1, in which the predominantly semicrystalline monomer is a diamine associated with a diacid, both these being aliphatic and linear.

4. The copolymer as claimed in claim 3, in which the aliphatic diamine has from 6 to 12 carbon atoms and the aliphatic diacid has from 9 to 12 carbon atoms.

5. The copolymer as claimed in claim 1, in which the comonomer introduced in order to reduce the crystallinity is a lactam, an alpha, omega-aminocarboxylic acid or a cyclic diamine associated with a diacid.

6. The copolymer as claimed in claim 1, in which the polyamide blocks are formed from lactam 12 (predominantly crystalline) and IPD 10 (isophorone diamine and sebacic acid).

7. The copolymer as claimed in claim 1, in which the polyamide blocks are formed from lactam 12 (predominantly crystalline) and from PACM 12 (PACM 20 and C₁₂ diacid).

8. The copolymer as claimed in claim 1, in which the polyamide blocks are formed from lactam 12 (predominantly crystalline) and either lactam 6 or 11-amino-undecanoic acid or lactam 6 and 11-amino-undecanoic acid.

9. The copolymer as claimed in claim 1, in which the crystalline monomer represents at least 55%, and preferably at least 70%, by weight of the constituents of the polyamide blocks.

10. The copolymer as claimed in claim 1, in which the amount of polyether blocks is from 10 to 40% by weight of the copolymer.

11. The copolymer as claimed in claim 1, in which the mass \overline{M}ₙ, of the polyether blocks is advantageously between 300 and 1100.

12. The copolymer as claimed in claim 1, in which the Shore D hardness is between 40 and 70.

13. An article manufactured with the copolymers as claimed in claim 1.
